(19) United States
(12) Patent Application Publication
(10) Pub. No.: US 2017/0068359 A1
(43) Pub. Date: Mar. 9, 2017

(54) Encapsulated Metal Nanowires

(71) Applicant: Apple Inc., Cupertino, CA (US)

(72) Inventors: Se Hyun Ahn, Cupertino, CA (US); Michael Vosgueritchian, Cupertino, CA (US); James E. Pedder, Cupertino, CA (US); Sunggu Kang, Cupertino, CA (US); Xiaofan Niu, Cupertino, CA (US)

(21) Appl. No.: 14/847,063

(22) Filed: Sep. 8, 2015

(51) Int. Cl. G06F 3/047; G06F 3/044; G06F 3/041

(52) U.S. Cl. CPC G06F 3/047; G06F 3/0412; G06F 3/044; G06F 2203/04103

(57) ABSTRACT

An optically-transparent conductive structure is disclosed. The optically-transparent conductive structure can be used within a display stack of an electronic device. The optically-transparent conductive structure may be formed by depositing a metal nanowire layer that on a surface of a polarizing layer within the display stack. An encapsulation layer is disposed over the metal nanowire layer that protects the metal nanowire from corrosion. An electrical coupling is provided through or within the encapsulation layer and electrically couples to the metal nanowire layer. The electrical coupling is connected to an electrical circuit within the electronic device.

### FIELD

Embodiments described herein generally relate to electronic devices, and more particularly, to transparent electrical conductors for electronic device displays.

### BACKGROUND

An electronic device can include a sensor to receive input. In some cases, the sensor is incorporated, either entirely or partially, into a display of the electronic device. Portions of the sensor within or adjacent the display, such as electrical conductors, are optically transparent so the presence of the sensor does not affect the clarity of the display.

Conventional optically-transparent electrical conductors have a high sheet resistance that undesirably bounds the sensitivity of a sensor incorporating the same. Additionally, such electrical conductors are typically manufactured using a physical vapor deposition or sputtering process which may be time-consuming and power intensive, requiring specialized machinery and/or highly-trained operating personnel.

### SUMMARY

Embodiments described herein may relate to, include, or take the form of an optically-transparent conductive structure that is integrated or incorporated into an input or sensor system of an electronic device. One embodiment described herein includes a conductive structure positioned below a cover of a display of an electronic device. The conductive structure includes a metal nanowire layer, an encapsulation layer disposed over the metal nanowire layer (thereby encapsulating the metal nanowire layer), and an electrical contact disposed adjacent the encapsulation layer. The encapsulation layer and the metal nanowire are substantially transparent. The electrical contact electrically couples the metal nanowire layer to an electrical circuit disposed within a housing of the electronic device.

In some embodiments, the conductive structure is disposed adjacent to a polarizer layer of the display. In one example, the conductive structure is deposited on a bottom surface of the polarizer layer.

In one embodiment, the metal nanowire layer includes a profusion of metal nanowires generally oriented in a common direction, although this is not required. The profusion of metal nanowires is suspended in a solvent which is drawn across a substrate (e.g., the bottom surface of a polarizer layer of the display of the electronic device). Shear forces resulting from the drawing process encourage the metal nanowires of the profusion to align in a common direction. The solvent can be thereafter evaporated, or otherwise removed, leaving a layer of commonly-oriented metal nanowires on the substrate. The encapsulation layer is disposed above the metal nanowire layer. The encapsulation layer protects the metal nanowire layer, shielding it from corrosion and other damage.

In some embodiments, the encapsulation layer is formed from a dielectric material. In other embodiments, the encapsulation layer is formed from an electrically-conductive material.

In one embodiment, the encapsulation layer defines a cavity (e.g., a via, a through-hole, a recess, an indentation, and so on). A deposit of conductive paste occupies the cavity and contacts the metal nanowire layer. The conductive paste seals against the sidewalls of the cavity. The conductive paste can be applied before, after, or with the encapsulation layer. For embodiments in which the encapsulation layer is deposited after the conductive paste is deposited, another layer of conductive paste can be deposited over the encapsulation layer to reduce contact resistance through the encapsulation layer.

In another embodiment, the encapsulation layer includes a conductive insert (e.g., disposed to contact the metal nanowire layer). The conductive insert provides an electrical path to the metal nanowire layer through the encapsulation layer. The electrical contact is disposed over the conductive insert. In these embodiments, the conductive insert completes a low-resistance electrical path between the metal nanowire layer and the electrical contact. As with other embodiments described herein, the electrical contact can be inserted at any suitable time, such as before the encapsulation layer is deposited, after the encapsulation layer is deposited but before the encapsulation layer is cured, or after the encapsulation layer is cured.

In some cases, the electrical contact physically contacts the conductive insert. In other embodiments, a portion of the encapsulation layer remains between the electrical contact and the conductive insert. In these embodiments, the conductive insert completes a low-resistance electrical path between the metal nanowire layer, the encapsulation layer, and the electrical contact.

In some embodiments, the encapsulation layer includes a conductive insert disposed within the encapsulation layer such that a portion of the encapsulation layer remains between the conductive insert and the metal nanowire layer. In these embodiments, the conductive insert completes a low-resistance electrical path between the metal nanowire layer, the encapsulation layer, and the electrical contact.

Further embodiments described herein may relate to, include, or take the form of an electronic device including a housing defining an aperture, an electrical circuit disposed within the housing, and a display positioned within the aperture. The display includes a cover, a conductive structure disposed below the cover. The conductive structure includes a metal nanowire layer, an encapsulation layer disposed over the metal nanowire layer, and an electrical contact disposed adjacent the encapsulation layer. The encapsulation layer protects the metal nanowire layer from corrosion. The electrical contact electrically couples the metal nanowire layer to the electrical circuit.

Additional embodiments described herein may relate to, include, or take the form of a method of forming a conductive structure including the operations of depositing a profusion of metal nanowires on a surface of a substrate, depositing an encapsulation layer over the metal nanowires, defining a cavity within the encapsulation layer, and depositing a conductor (e.g., silver paste) within the cavity such that the electrical resistance between the conductor and the profusion of metal nanowires is less than the electrical resistance between a top surface of the encapsulation layer and the profusion of metal nanowires.

In one embodiment, the cavity is a through-hole and the conductor contacts the profusion of metal nanowires. In other embodiments, the cavity is a recess or indentation that only partially extends through the encapsulation layer toward the profusion of metal nanowires.

In one embodiment, defining a cavity within the encapsulation layer includes curing the encapsulation layer, and ablating the encapsulation layer (before, during, and/or after curing) with a laser.

In another embodiment, defining a cavity within the encapsulation layer includes curing the encapsulation layer, applying a mask to the encapsulation layer, and etching the encapsulation layer with an etchant.

In further embodiments, defining a cavity within the encapsulation layer includes disposing a cure mold over the encapsulation layer, curing the encapsulation layer, removing the cure mold from the encapsulation layer.

In one embodiment, defining a cavity within the encapsulation layer includes (prior to depositing an encapsulation layer) disposing a dewetting material over the metal nanowires, depositing an encapsulation layer over the metal nanowires, curing the encapsulation layer, and removing dewetting material. In many cases, the dewetting material is deposited in a pattern. In one example, the dewetting material is disposed in a rectangular shape along one edge of the profusion of metal nanowires.

In one embodiment, the dewetting material is an oleophobic material. In another embodiment, the dewetting material is a hydrophobic material.

In these and other embodiments, the profusion of metal nanowires is deposited using a roll-to-roll process.

Additional embodiments described herein may relate to, include, or take the form of a method of forming a conductive structure, the method including at least depositing a profusion of metal nanowires on a surface of a substrate, depositing an encapsulation layer of protectant over the metal nanowires, depositing a conductive insert within the encapsulation layer, curing the encapsulation layer, and depositing an electrical contact over the conductive insert such that the electrical resistance between the electrical contact and the profusion of metal nanowires is less than the electrical resistance between a top surface of the encapsulation layer and the profusion of metal nanowires. As with other embodiments described herein, the conductive insert can be applied and/or deposited before, after, or with the encapsulation layer. In some embodiments, the conductive insert can be applied and/or deposited after or with the operation of depositing the profusion of metal nanowires on the substrate.

### BRIEF DESCRIPTION OF THE FIGURES

Reference will now be made to representative embodiments illustrated in the accompanying figures. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

FIG. 1 depicts an electronic device with a display incorporating an optically-transparent conductive structure with reduced contact and sheet resistance.

FIG. 2A depicts a representative partial cross-section of the display of FIG. 1, depicting the conductive structure.

FIG. 2B is a detail view of the enclosed circle B-B of FIG. 2A, particularly depicting a representative partial cross-section of the conductive structure.

FIG. 3A depicts a representative partial cross-section a conductive structure, showing metal nanowires dispersed on a substrate.

FIG. 3B depicts the conductive structure of FIG. 3A, showing a local application of dewetting material to the metal nanowires.

FIG. 3C depicts the conductive structure of FIG. 3B, showing an encapsulation layer abutting the dewetting material, thereby defining a cavity in the encapsulation layer.

FIG. 3D depicts the conductive structure of FIG. 3C, showing the cavity defined by the encapsulation layer after removal of the dewetting material and curing of the encapsulation layer.

FIG. 3E depicts the conductive structure of FIG. 3D, showing the cavity filled with an electrical contact providing a low-resistance electrical path through the encapsulation layer to the metal nanowires.

FIG. 4A depicts a representative partial cross-section a conductive structure, showing metal nanowires dispersed on a substrate.

FIG. 4B depicts the conductive structure of FIG. 4A, showing a local application of light-absorbing material to the metal nanowires.

FIG. 4C depicts the conductive structure of FIG. 4B, showing an encapsulation layer disposed over the light-absorbing material.

FIG. 4D depicts the conductive structure of FIG. 4C, showing a cavity defined in the encapsulation layer after the encapsulation layer and light-absorbing material are exposed to laser light.

FIG. 4E depicts the conductive structure of FIG. 4D, showing the cavity filled with an electrical contact, providing a low-resistance electrical path through the encapsulation layer to the metal nanowires.

FIG. 5A depicts a representative partial cross-section a conductive structure, showing metal nanowires dispersed on a substrate.

FIG. 5B depicts the conductive structure of FIG. 5A, showing an encapsulation layer disposed over the metal nanowires.

FIG. 5C depicts the conductive structure of FIG. 5B, showing a cure mold disposed over the encapsulation layer.

FIG. 5D depicts the conductive structure of FIG. 5C, showing removal of the cure mold from the encapsulation layer after the encapsulation layer is cured.

FIG. 5E depicts the conductive structure of FIG. 5D, showing a cavity defined in the encapsulation layer.

FIG. 5F depicts the conductive structure of FIG. 5E, showing the cavity filled with an electrical contact, providing a low-resistance electrical path through the encapsulation layer to the metal nanowires.

FIG. 6A depicts a representative partial cross-section a conductive structure, showing metal nanowires dispersed on a substrate.

FIG. 6B depicts the conductive structure of FIG. 6A, showing an encapsulation layer disposed over the metal nanowires.

FIG. 6C depicts the conductive structure of FIG. 6B, showing a conductive insert embedded within the encapsulation layer

FIG. 6D depicts the conductive structure of FIG. 6C, showing an electrical contact disposed over the conductive insert, providing a low-resistance electrical path through the encapsulation layer to the metal nanowires.

FIG. 7A depicts a representative partial cross-section a conductive structure, showing metal nanowires dispersed on a substrate.

FIG. 7B depicts the conductive structure of FIG. 7A, showing an encapsulation layer disposed over the metal nanowires.

FIG. 7C depicts the conductive structure of FIG. 7B, showing a conductive insert embedded within the encapsulation layer

FIG. 7D depicts the conductive structure of FIG. 7C, showing an electrical contact disposed over the conductive insert providing a low-resistance electrical path through the encapsulation layer to the metal nanowires.

FIG. 8A depicts a representative partial cross-section a conductive structure, showing metal nanowires dispersed on a substrate.

FIG. 8B depicts the conductive structure of FIG. 8A, showing an encapsulation layer disposed over the metal nanowires.

FIG. 8C depicts the conductive structure of FIG. 8B, showing an electrical contact disposed above the encapsulation layer.

FIG. 8D depicts the conductive structure of FIG. 8C, showing a second encapsulation layer abutting the electrical contact, providing a low-resistance electrical path through the encapsulation layer to the metal nanowires.

FIG. 8E depicts the conductive structure of FIG. 8C, showing a second encapsulation layer disposed over the electrical contact, providing a low-resistance electrical path through the encapsulation layer to the metal nanowires.

FIG. 9A depicts a representative partial cross-section a conductive structure, showing metal nanowires dispersed on a substrate.

FIG. 9B depicts the conductive structure of FIG. 9A, showing an electrical contact disposed over the metal nanowires.

FIG. 9C depicts the conductive structure of FIG. 9B, showing a mask disposed over the electrical contact.

FIG. 9D depicts the conductive structure of FIG. 9C, showing an encapsulation layer disposed over the electrical contact and the profusion of metal nanowires.

FIG. 9E depicts the conductive structure of FIG. 9D, showing removal of the mask through the encapsulation layer, leaving a cavity defined in the encapsulation layer.

FIG. 9F depicts the conductive structure of FIG. 9E, showing the cavity filled with a second application of the electrical contact material, providing a low-resistance electrical path through the encapsulation layer to the metal nanowires.

FIG. 10 is a simplified flow chart illustrating example operations of a method of forming a conductive structure that is optically transparent and exhibits reduced contact resistance.

FIG. 11 is a simplified flow chart illustrating example operations of another method of forming a conductive structure that is optically transparent and exhibits reduced contact resistance.

FIG. 12 is a simplified flow chart illustrating example operations of yet another method of forming a conductive structure that is optically transparent and exhibits reduced contact resistance.

FIG. 13 is a simplified flow chart illustrating example operations of yet another method of forming a conductive structure that is optically transparent and exhibits reduced contact resistance.

FIG. 14 is a simplified flow chart illustrating example operations of yet another method of forming a conductive structure that is optically transparent and exhibits reduced contact resistance.

FIG. 15 is a simplified flow chart illustrating example operations of a method of coupling a conductive structure to an electrical circuit.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein reference displays for electronic devices incorporating a conductive structure with low sheet resistance and low contact resistance. The conductive structure is substantially optically transparent. In one example, the conductive structure is coupled to a sensor circuit, such as a touch sensor or a force sensor. In another example, the conductive structure is coupled to a communications circuit. In yet another example, the conductive structure is an electromagnetic interference shield, a ground plane, a shield layer, or a combination thereof.

Other embodiments described herein reference transparent conductors having low sheet resistance that can be manufactured at high speed using a roll-to-roll manufacturing technique. For example, a conductive structure can be formed by dispersing a profusion of metal nanowires onto a substrate. As used herein, the phrase “profusion of metal nanowires” generally refers to a number or set of metal nanowires, either independently or suspended in a liquid or solid. Typically, the substrate is an optically-transparent and non-conductive (e.g., dielectric) substrate such as glass or polyethylene terephthalate. In some embodiments, the substrate is a polarizer layer of a display stack.

The metal nanowires are suspended in a non-corrosive solvent and/or binder that may be removed or cured after the profusion of metal nanowires is dispersed on the substrate. In some embodiments, the solvent or binder may be removed after the metal nanowires are deposited on the substrate. In other cases, the binder may be cured after the metal nanowires are deposited on the substrate.

Metal nanowire layers, such as those described herein, exhibit lower sheet resistance than conventional metal-oxide layers when each has a thickness that renders the layers optically transparent. For example, the sheet resistance of an optically-transparent metal nanowire layer can be less than one tenth the sheet resistance of an optically-transparent metal-oxide layer. As a result of the improved conductivity, an optically-transparent metal nanowire layer can be thinner than an optically-transparent metal-oxide layer. In one example, the reduced sheet resistance of a metal nanowire layer may be particularly advantageous for forming a component of a sensing circuit, such as a conductive plate of a capacitive force sensor incorporated within a display of a large form-factor electronic device.

The concentration of the metal nanowires impacts the sheet resistance as well as the optical transparency of a layer formed therewith; the greater the concentration of metal nanowires, the lower the sheet resistance and optical transparency.

Individual nanowires are either solid or hollow and can vary in length. In some examples, a single profusion of metal nanowires can include more than one type of metal nanowire. For example, a profusion of silver nanowires can be mixed with a profusion of gold or platinum nanowires in various proportions such that when dispersed, the layer exhibits different sheet resistance than a dispersion of silver nanowires alone. In some cases, nanowires are formed from a single metal. In other cases, individual metal nanowires can be formed from an alloy of two or more metals.

Dispersions of metal nanowires may be sensitive to corrosion such as galvanic corrosion and oxidation. Also, certain types of metal nanowires, such as silver nanowires, can be sensitive to chemical corrosion. For example, silver nanowires may corrode and develop coatings, pockets, or other formations of silver sulfide upon exposure to sulfur. Accordingly, many embodiments described herein encapsulate a profusion of metal nanowires in a corrosion-resistant material. In many embodiments, an encapsulation layer is disposed above a profusion of metal nanowires. An encapsulation layer can be formed from a conductive polymer, a dielectric polymer, or another material. The thickness of the encapsulation layer can correspond to a degree of corrosion protection afforded the dispersion of the metal nanowires; the thicker the encapsulation layer, the greater the protection provided. In some embodiments, an encapsulation layer is approximately 200 nm thick. In other examples, thicker or thinner encapsulation layers are used.

In many cases, a thick encapsulation layer increases the difficulty of making an electrical connection to the metal nanowires. More specifically, the contact resistance exhibited by the top surface (and thickness) of the encapsulation layer may be undesirably high. As may be appreciated, an encapsulation layer exhibiting high contact resistance diminishes the advantages of the metal nanowire layer it protects.

Accordingly, certain embodiments described herein employ and/or take the form of methods for reducing the contact resistance of encapsulated metal nanowires. In an alternate and non-limiting phrasing, many embodiments described herein reference methods for forming and/or defining a low-resistance electrical path through an encapsulation layer to a profusion of metal nanowires disposed below.

In one example, an electrical contact extends entirely or partly through the encapsulation layer, thereby forming a low-resistance electrical path from the electrical contact, through (at most) a thin portion of the encapsulation layer, to the metal nanowires.

In another example, an electrically-conductive plate is embedded within the encapsulation layer, thereby forming a low-resistance electrical path from the top surface of the encapsulation layer, through a thin portion of the encapsulation layer above the embedded plate, through the embedded plate, and through a thin portion of the encapsulation layer below the embedded plate to the metal nanowires. The electrically-conductive plate can be embedded within the encapsulation layer by placing the electrically-conductive plate over the substrate (e.g., suspending it) prior to depositing the encapsulation layer. In another embodiment, the electrically-conductive plate can be embedded within the encapsulation layer after the encapsulation layer is deposited but prior to a curing operation. In still further embodiments, the electrically-conductive plate can be embedded within an encapsulation layer that is partially cured (e.g., cured to a selected depth, cured to a selected rigidity, and so on). In still further embodiments, the electrically-conductive plate can be embedded within a cured encapsulation layer that is locally etched away via a chemical, electrical, or mechanical etching or ablating process. Once the electrically-conductive insert is inserted within the locally etched region, a sealing layer can be deposited over the electrically-conductive insert to seal the insert within the encapsulation layer. The sealing layer can be the same material as the encapsulation layer, although this is not required and other electrically conductive or dielectric materials may be used.

In another example, a thin encapsulation layer is deposited over a profusion of metal nanowires. An electrical contact is above the thin encapsulation layer. Thereafter, a second layer of encapsulation material is disposed so as to increase the thickness of the encapsulation layer. In some cases, the second layer of encapsulation material is disposed over the electrical contact. The second layer of can be from the same material as the first layer, but this is not required. In other cases, the second layer of encapsulation layer material is abutting sidewalls of the electrical contact. In these embodiments, a low-resistance electrical path is formed from the electrical contact, through the thin portion of the encapsulation layer to the metal nanowires.

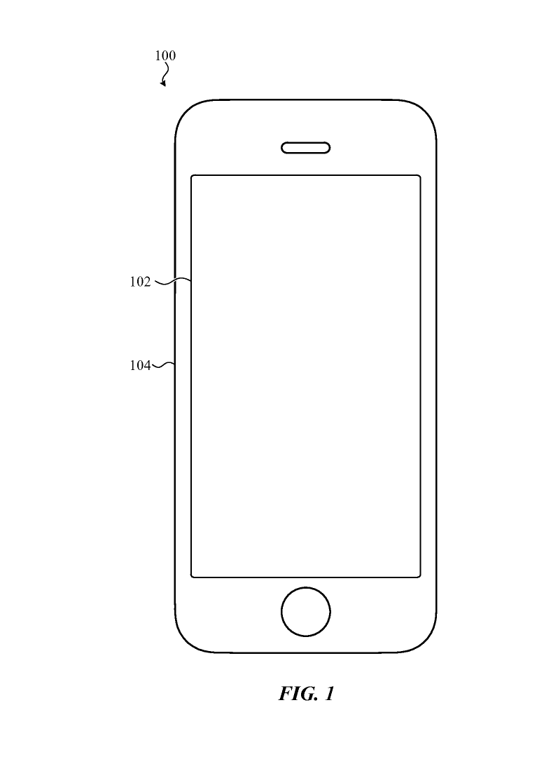

These and other embodiments, and various example methods of manufacturing the same, are discussed below with reference to FIGS. 1-15. However, those skilled in the art will readily appreciate that the detailed description given herein with respect to these figures is for explanatory purposes only and should not be construed as limiting.

FIG. 1 depicts an electronic device 100 with a display 102. The electronic device 100 is depicted as a cellular phone, although this form-factor is not required of all embodiments. For example, the electronic device 100 can be any suitable device such as a desktop computer, laptop computer, tablet computer, an industrial or commercial computing terminal, a peripheral or integrated input device, a hand-held or battery powered portable electronic device, a navigation device, a wearable device, and so on.

The display 102 is within a housing 104. In one example, an exterior surface of the display 102 is flush with an exterior surface of the housing 104. In this manner, the display 102 cooperates with the housing 104 to form a substantially continuous external surface of the electronic device 100. In other examples, the display 102 may take a non-planar shape, such as a curved or partially curved shape.

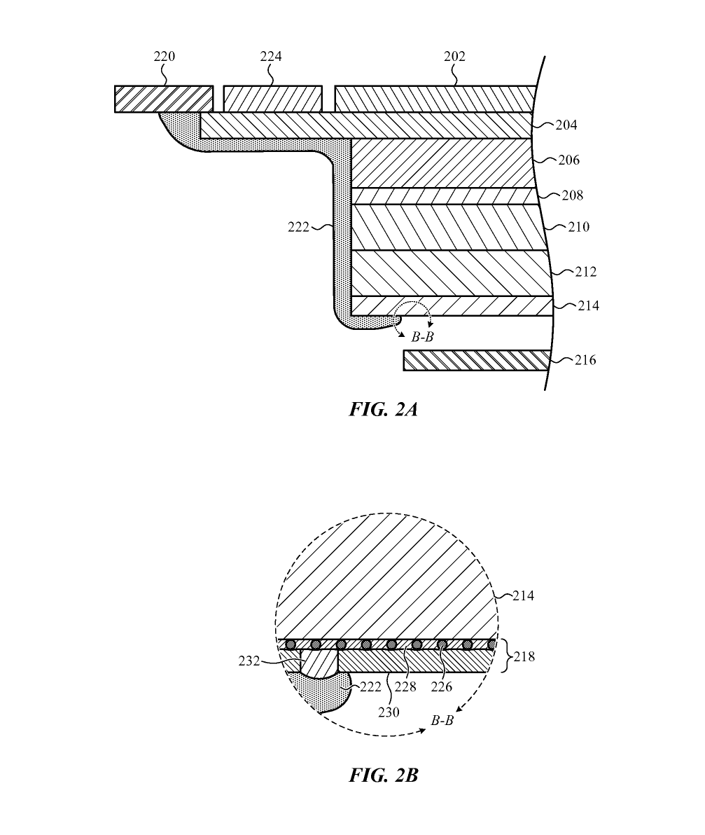

The display 102 may include a stack of multiple elements (see, e.g., FIGS. 2A-2B) including, for example, a display element, a touch sensor layer, a force sensor layer, a color filter layer, a polarizer layer, and other elements or layers. The display 102 may include a liquid-crystal display element, organic light emitting diode element, electroluminescent display, and the like. The display 102 may also include other layers for improving the structural or optical performance of the display, including, for example, glass sheets, polymer sheets, polarizer sheets, color masks, and the like. The display 102 can be integrated or incorporated with a cover, which forms part of the exterior surface of the electronic device 100. In many examples, the cover is formed from glass or another suitable material such as plastic, sapphire, ion-implanted glass, and so on. In some cases, the cover is a solid material whereas in other cases the cover is formed by laminating or adhering several materials together.

In many embodiments, one or more of the layers included within the display 102 may be formed, at least in part, from a profusion of metal nanowires.

FIG. 2A depicts a representative partial cross-section of an interior portion of the display 102 of the electronic device 100. For example, the various elements depicted in FIG. 2A may be disposed within the housing 104 and below the cover of the display 102 of the electronic device of FIG. 1. FIG. 2B depicts a detail view of the enclosed circle B-B of FIG. 2A, particularly depicting encapsulated metal nanowires.

As noted above, the display 102 can be a liquid crystal display that includes several layers (e.g., the “display stack”) that are adhered to, bonded to, or positioned adjacent to one another. The embodiment illustrated in FIGS. 2A-2B is merely a partial example of one such display stack; other embodiments include additional or fewer layers or a different layer order. Further, the embodiment is not illustrated to scale and thus the illustrated thicknesses of the various layers are not intended to indicate any preference or requirement for particular dimensions, either relative or absolute.

In the illustrated embodiment, the display stack includes a color filter layer 202. The color filter layer 202 includes at least one dyed or colored region. A transparent circuit layer 204 is below the color filter layer 202. In one example, the transparent circuit layer 204 is a thin-film transistor layer. The transparent circuit layer 204 can selectively control the polarization of light passing therethrough, cooperating with the color filter layer 202 to form one or more pixels or subpixels of the display. An adhesive layer 206 adheres to the underside of the transparent circuit layer 204. In one example, the adhesive layer 206 is a pressure sensitive adhesive. The adhesive layer 206 attaches an encapsulation layer 210 to the transparent circuit layer 204. In one example, the encapsulation layer is a polyvinyl alcohol. An insulator layer 212 is below the encapsulation layer 210. The insulator layer 212 is formed, in one example, from cellulous triacetate.

A polarizer layer 214 is below the insulator layer 212. In one example, the polarizer layer 214 includes, or takes the form of, a polarizing film. In some cases, the polarizer layer 214 may function as a rear polarizer for the display 102.

The display stack depicted can be placed above a light source such as a backlight 216. The backlight 216 is used to illuminate the color filter layer 202 through the transparent circuit layer 204. In one example, the backlight 216 includes a light emitting element, such as a light emitting diode, configured to emit white light. In another example, the backlight 216 is an array of individually-addressable light emitting elements that emit white light separately or cooperatively. In another example, the backlight 216 is a diffusive sheet of translucent material with one or more light emitting elements coupled to an edge thereof.

In one embodiment the backlight 216 is separated from a bottom surface of the polarizer layer 214. When a downward force is applied to the display stack (e.g., by a user), the display stack may deform toward the backlight 216.

A conductive structure 218 can be disposed directly on the bottom surface of the polarizer layer 214. The conductive structure 218 is substantially optically transparent. In other embodiments, the conductive structure 218 can be deposited on a different surface of a different layer of the display stack. In yet other embodiments, the conductive structure is deposited on an optically-transparent substrate that itself is included within the display stack. In yet other embodiments, the conductive structure is deposited on another surface of the electronic device, such as on the underside of the cover of the display 102 of the electronic device 100 of FIG. 1.

In the illustrated embodiment, the conductive structure 218 is coupled to a flex 220, for example, via a jumper 222. In many embodiments, the jumper 222 is formed by depositing an electroconductive paste onto a sidewall of the display stack in a manner that partially overlaps the bottom surface of the polarizer layer 214. In one embodiment the electroconductive paste is silver paste.

The flex 220 provides an electrical connection between the conductive structure 218 and an electrical circuit within the electronic device. The electrical circuit can be disposed, at least partially, onto or within one or more layers of the display stack. In one example, the electrical circuit is a portion of a display driver 224 that is disposed directly onto a surface of the transparent circuit layer 204.

As noted above, a conductive structure, such as the conductive structure 218, can be included in the display stack for a variety of purposes. In one example, the conductive structure 218 is a portion of a sensor circuit such as a force sensor or a touch sensor. For example, in one embodiment, the sensor circuit is a capacitive sensor circuit configured to measure a capacitance associated with the conductive structure 218. For example, the capacitive sensor circuit can be configured to measure a capacitance between the conductive structure 218 and another electrically-conductive surface or layer positioned nearby. In one example, the capacitance measured by the sensor corresponds to a change in the distance between the conductive structure 218 and the other electrically-conductive surface which, in turn, corresponds to a magnitude of force applied to the display stack by a user. In this example, the electrical circuit and the conductive structure 218 cooperate to function as a force-sensitive input sensor.

In another example, the conductive structure 218 forms a portion of a communications circuit. In yet another example, the conductive structure 218 can form a portion of an electromagnetic shield. In yet another example, the conductive structure 218 serves more than one purpose; in a first mode, the conductive structure 218 can be a portion of a sensor and in a second mode, the conductive structure 218 can be a portion of a communication circuit.

The conductive structure 218 can be formed as a single contiguous layer across the entire area of the polarizer layer 214. Alternatively, the conductive structure 218 is disposed in a pattern such as an array. In other examples, the conductive structure 218 can be formed into columns or rows or any other suitable pattern, including uneven patterns or multiple patterns cooperating to form the layer.

The conductive structure 218 includes a metal nanowires 226 disposed within a binder 228. The metal nanowires 226 cooperate to form a conductive network across the polarizer layer 214. The metal nanowires do not necessarily need to touch one another to form a conductive network; in some examples, the metal nanowires are randomly or semi-randomly aligned and spaced.

Although the metal nanowires 226 are illustrated as having each nanowire of the dispersion oriented in the same direction (e.g., with an end of each nanowire oriented out of the illustration page), it is appreciated that such a configuration is not required. For example, many of the nanowires may be oriented in a direction different than that shown. Many individual nanowires may overlap with one or more nanowires adjacent to them. Additionally, in some embodiments, the metal nanowires may form an anisotropic layer.

In some embodiments more than one layer of metal nanowires is dispersed on the polarizer layer 214 (or another layer within the display stack). In these cases, a first layer of metal nanowires can be dispersed so that the nanowires are generally oriented in a first common direction and a second layer of metal nanowires can be dispersed so that the nanowires are generally oriented in a second common direction. In some examples, the first common direction can be orthogonal to the second common direction.

The binder 228 may be formed from a material adheres the metal nanowires 226 to the bottom surface of the polarizer layer 214 and/or another surface or layer adjacent to the metal nanowires. For example, the binder 228 can be an optically clear adhesive such as an acrylic adhesive. In other cases, the binder 228 may not be required.

The conductive structure 218 also includes an encapsulation sublayer 230. The encapsulation sublayer 230 protects the binder 228 and the metal nanowires 226. The encapsulation sublayer 230 can have a thickness that is greater than that of the metal nanowires 226 and the binder 228. The encapsulation sublayer 230 is formed from an optically clear material. In many examples, the encapsulation sublayer 230 is formed from a corrosion-resistant material. The thickness of the encapsulation sublayer 230 can vary from embodiment to embodiment.

In many cases, the encapsulation sublayer 230 is formed from an electrically-conductive material, such as an electroconductive polymer or a metal-oxide such as indium-tin oxide. In these cases, the jumper 222 can complete an electrical circuit to the metal nanowires 226 through the encapsulation sublayer 230. However, in many cases, the resistance exhibited by the encapsulation sublayer 230 increases with the thickness of the sublayer. In other words, an encapsulation sublayer that is of a thickness that affords adequate implementation-specific protection to the metal nanowires 226 may exhibit an electrical resistance (e.g., contact resistance) that is undesirably high.

Accordingly, embodiments described herein reference methods for reducing the contact resistance of an encapsulation sublayer of a conductive structure, such as the encapsulation sublayer 230 of the conductive structure 218.

In one example, an electrical bridge 232 is defined entirely through the encapsulation sublayer 230. As illustrated, the electrical bridge 232 can be an electrically-conductive plug or insert that directly connects the jumper 222 to the metal nanowires 226. In this manner, a complete electrical path is formed from the metal nanowires 226, through the electrical bridge 232, to the jumper 222.

The electrical bridge 232 is formed from a metal material having low electrical resistance. In one example, the electrical bridge 232 is formed from metal, metal-oxide, conductive polymer, silver paste, solder paste, metal powder, conductive adhesive, metalized grease, or another electroconductive paste or grease.

In other embodiments, the contact resistance of the encapsulation sublayer 230 is reduced in another manner. In one example, an electrical contact that is coupled to the jumper 222 extends partly through the encapsulation sublayer 230, thereby forming a low-resistance electrical path from jumper 222, through the electrical contact, through a thin portion of the encapsulation sublayer 230, to the metal nanowires 226.

In another example, an electrically-conductive plate is embedded within the encapsulation sublayer 230, thereby forming a low-resistance electrical path from the jumper 222, through the top surface of the encapsulation sublayer 230, through a thin portion of the encapsulation sublayer 230 above the embedded plate, through the embedded plate, through a thin portion of the encapsulation sublayer 230 below the embedded plate to the metal nanowires 226. In this manner, the thin portion of the encapsulation layer has a relatively lower electrical resistance in comparison to the full thickness of the encapsulation layer. In many cases, the embedded plate is disposed within or nearby a perimeter portion of the encapsulation sublayer 230.

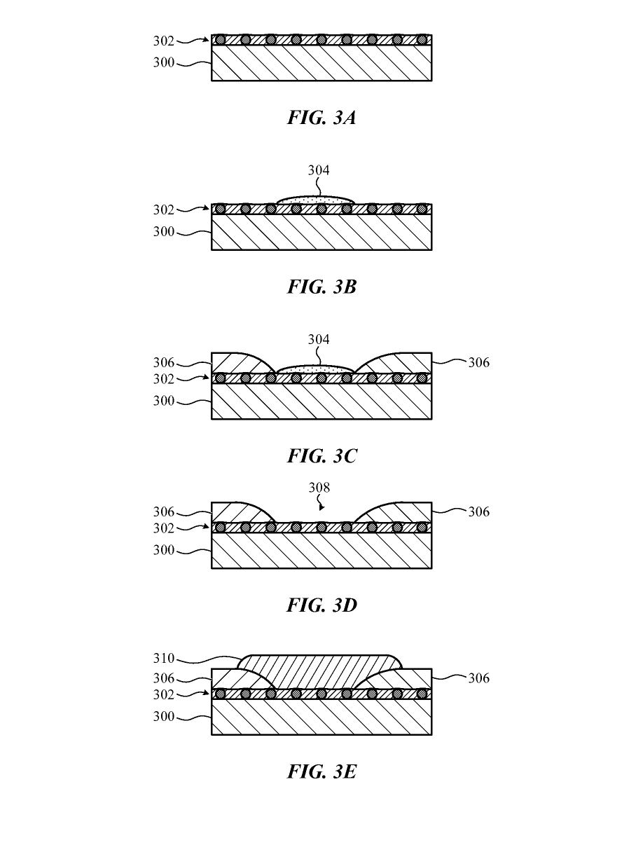

For example, FIGS. 3A-3E depict intermediate operations of a method of forming a conductive structure that is substantially optically transparent by encapsulating a profusion of metal nanowires and disposing an electrical contact through the encapsulation. In these embodiments, the contact resistance through the encapsulation sublayer is reduced by forming a cavity or channel within the encapsulation sublayer (either prior to, during, or after curing of the encapsulation sublayer) and filling said cavity or channel with an electrical contact material such as an electroconductive paste. The electrical contact completes an electrical connection to the metal nanowire layer.

FIG. 3A depicts a representative partial cross-section a conductive structure, showing a profusion of metal nanowires dispersed on a substrate 300. A profusion of metal nanowires 302 is coupled, adhered, laminated, or bonded to a surface of the substrate 300. As with other embodiments described herein, the substrate 300 is a non-conductive (e.g., dielectric) substrate 300 such as glass or polyethylene terephthalate. As noted above, in some embodiments, the substrate 300 is a polarizer layer of a display stack, such as the polarizer layer 214 as shown in FIGS. 2A-2B.

In some cases, the profusion of metal nanowires 302 includes a binder. As with other embodiments described herein, the binder can be a conductive or non-conductive material. In some cases, the binder is an adhesive that couples the profusion of metal nanowires 302 to the substrate 300.

The profusion of metal nanowires 302 may be applied to the substrate 300 by inkjet printing (such as continuous or drop-on-demand inkjet printing), roll-to-roll printing, electrostatic deposition, manual deposition, or any other suitable method. In some cases, distinct deposits of profusion of metal nanowires adjacent to one another may be merged.

FIG. 3B depicts the conductive structure of FIG. 3A, showing a local application of a dewetting material 304 to the metal nanowires 302. The dewetting material 304 establishes a distinct boundary for the encapsulation sublayer 306 from the surface of the profusion of metal nanowires 302. The dewetting material 304 can be hydrophobic or oleophobic or another material that encourages dewetting of the material selected for the encapsulation sublayer 306.

In many cases, the dewetting material 304 is a material that does not interact with the profusion of metal nanowires 302.

In many cases, the dewetting material 304 is applied in a pattern. In one example, the dewetting material 304 is applied as a linear series of circular dots nearby the perimeter of the profusion of metal nanowires 302. In one example, the dewetting material 304 is applied as a rectangle abutting the perimeter of the profusion of metal nanowires 302, such as a rectangular ring.

In one example, the dewetting material 304 is a liquid material applied by inkjet printing (such as continuous or drop-on-demand inkjet printing), roll-to-roll printing, electrostatic deposition, manual deposition, or any other suitable method. In some cases, distinct deposits of dewetting material adjacent to one another may be encouraged to merge in any suitable manner. For example, distinct deposits of dewetting material can be vibrated or pressed so that adjacent deposits merge together.

In some cases, the dewetting material 304 is a solid material, such as plastic, that is deposited on the profusion of metal nanowires 302 by pick-and-place. In yet another example, the dewetting material 304 can be a stream jet that propels gas, liquid, or a particle stream at the profusion of metal nanowires 302 during the deposition and/or curing of the encapsulation sublayer 306.

The encapsulation sublayer 306 is disposed above the profusion of metal nanowires 302 and the dewetting material 304, such as shown in FIG. 3C. The thickness of the encapsulation sublayer 306 can be uniform or non-uniform. For example, a perimeter portion of the encapsulation sublayer 306 may be thinner than an interior portion of the encapsulation sublayer 306 (not shown).

As with other portions of the conductive structure, the encapsulation sublayer 306 can be deposited as a liquid material, applied by inkjet printing (such as continuous or drop-on-demand inkjet printing), roll-to-roll printing, electrostatic deposition, manual deposition, or any other suitable method. In some cases, distinct deposits of the encapsulation material deposited adjacent to one another may be encouraged to merge.

The dewetting material 304 can be removed to expose a cavity 308, such as shown in FIG. 3D. In one example, the encapsulation sublayer 306 is cured prior to removal of the dewetting material 304. Curing may occur by exposing the encapsulation sublayer 306 to ultraviolet light, pressure, or heat. The dewetting material 304 is removed by evaporation, extraction, dissolution, or another suitable method. In some cases, the dewetting material 304 can be electrically conductive and may not necessarily be removed.

An electrical contact 310 is disposed within the cavity 308 of the encapsulation sublayer 306, such as shown in FIG. 3E. In one example, the electrical contact 310 is flush with a top surface of the encapsulation sublayer 306. In another embodiment, the electrical contact 310 extends proud of the top surface of the encapsulation sublayer 306. In this example, the electrical contact 310 can be disposed to overflow from the cavity 308 such as illustrated. A portion of the electrical contact 310 can interface and/or be adhered or coupled to a top surface of the encapsulation sublayer 306.

In this manner, an electrical circuit is formed through the encapsulation sublayer 306 by electrically coupling the electrical contact 310 directly to the metal nanowires deposited on the substrate 300. Such a configuration exhibits lower electrical resistance than would be provided by an encapsulation sublayer of equal thickness. Similarly, such a configuration provides more protection to the metal nanowires 302 than a thinner encapsulation sublayer. In this manner, the profusion of metal nanowires 302 is effectively encapsulated while retaining low sheet resistance.

In another embodiment, a wetting material can be used in place of the dewetting material 304. In this example, the wetting material can be applied across the entire surface of the profusion of metal nanowires 302 save for select locations. For example, a wetting material can be applied everywhere across the profusion of metal nanowires 302 save for the illustrated location of the dewetting material 304. The wetting material encourages wetting of the encapsulation sublayer 306 to the surface of the profusion of metal nanowires 302. The wetting material can be hydrophilic or oleophilic or another material that encourages wetting material of the material selected for the encapsulation sublayer 306.

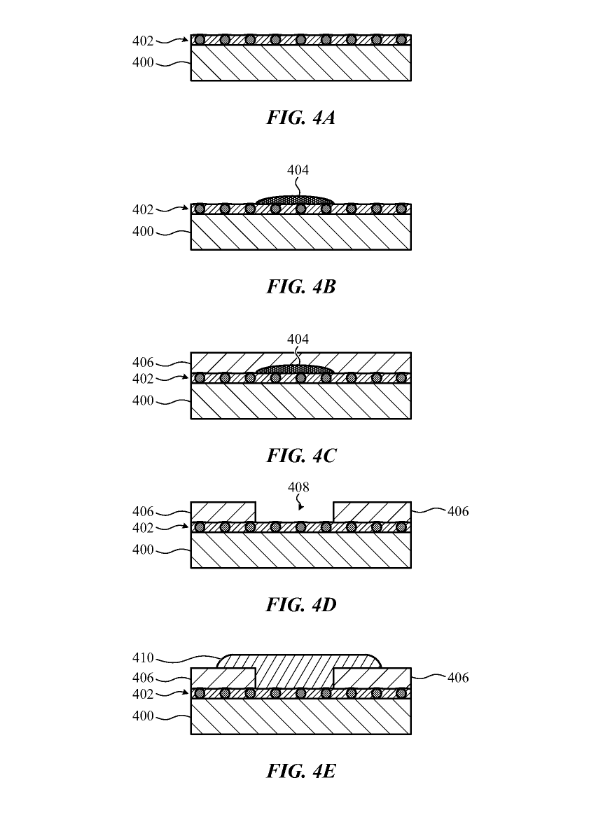

FIG. 4A depicts a representative partial cross-section another conductive structure, showing metal nanowires dispersed on a substrate 400. A profusion of metal nanowires 402 is coupled, adhered, laminated, or bonded to a surface of the substrate 400. As with other embodiments described herein, the profusion of metal nanowires 402 can include a binder, but this is not necessarily required. Additionally, more than one layer of metal nanowires can be included in certain embodiments. The profusion of metal nanowires 402 is substantially optically transparent.

As with the embodiments described above, the profusion of metal nanowires 402 is applied to the substrate 400 by inkjet printing (such as continuous or drop-on-demand inkjet printing), roll-to-roll printing, electrostatic deposition, manual deposition, or any other suitable method.

FIG. 4B depicts the conductive structure of FIG. 4A, showing a local application of a light-absorbing material 404 to the metal nanowires 402. The light-absorbing material 404 is a sacrificial or non-sacrificial material that absorbs visible light, infrared light, and/or ultraviolet light that might otherwise pass through the conductive structure. In this manner, the light-absorbing material 404 facilitates and/or guides the evaporation or disintegration of the encapsulation sublayer 406 above it when the light-absorbing material 404 is exposed to high-energy laser light. The light-absorbing material 404 is disposed using any suitable manner. Thereafter, the encapsulation sublayer 406 is deposited over the light-absorbing material 404, such as shown in FIG. 4C. In other embodiments, a light-absorbing material may not be required.

The light-absorbing material 404, as the portion of the encapsulation sublayer 406 adjacent to the light-absorbing material 404, is exposed to laser light.

Laser exposure may involve directing a focused beam of light at a surface of the encapsulation sublayer 406 above the light-absorbing material 404. The material of the encapsulation sublayer 406 may be melted, burned, ablated, or otherwise vaporized as a result to expose a cavity 408, such as shown in FIG. 4D. The heated material may be blown free by a gas or liquid jet or may be vaporized. The focal point of the laser may be set along the top surface of the encapsulation sublayer 406 or the bottom surface of the encapsulation sublayer 406, or anywhere in between. The wavelength of the focused beam of light can vary from embodiment to embodiment and can be steady or can vary. In some cases, the amplitude of the focused beam of light can vary during the exposure. In some cases, the focal point of the focused beam of light can vary during the exposure.

Thereafter, an electrical contact 410 is disposed within the cavity 408 of the encapsulation sublayer 406, such as shown in FIG. 4E.

In this manner, an electrical circuit is formed through the encapsulation sublayer 406 by electrically coupling the electrical contact 410 directly to the metal nanowires deposited on the substrate 400. Such a configuration exhibits lower electrical resistance than would be provided by an encapsulation sublayer 406 of equal thickness. In this manner, the profusion of metal nanowires 402 is effectively encapsulated while retaining low sheet resistance.

In another related embodiment, the cavity 408 may not extend through the entire depth of the encapsulation sublayer 406. In another non-limiting phrasing, the cavity 408 can be a locally-thinned portion of the encapsulation sublayer 406. In this embodiment, the depth of the cavity can be selected based, at least in part, based on the conductivity of the material selected for the encapsulation sublayer 406. For example, if the encapsulation sublayer 406 is formed from an electrically-conductive material with high conductivity, then the cavity may be shallower than if the encapsulation sublayer 406 is formed from an electrically-conductive material with low conductivity.

As with the depicted embodiment, the electrical contact 410 is disposed within the cavity 408 of the encapsulation sublayer 406. In this manner, an electrical circuit is formed through the thickness of the encapsulation sublayer 406 by electrically coupling the electrical contact 410 through a thin portion of the encapsulation sublayer 406, to the metal nanowires 402 deposited on the substrate 400. Such a configuration exhibits lower electrical resistance than would be provided by an encapsulation sublayer 406 of equal thickness. In this manner, the profusion of metal nanowires 402 is effectively encapsulated while retaining low sheet resistance.

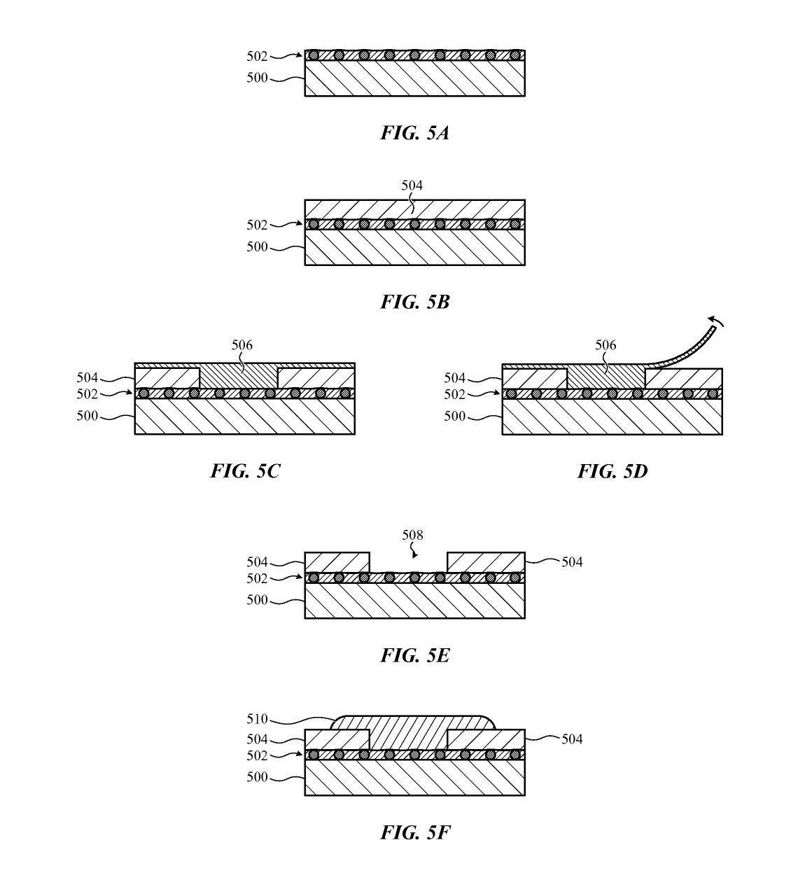

FIGS. 5A-5F depict intermediate operations of another method of forming a conductive structure that is substantially optically transparent by encapsulating a profusion of metal nanowires and disposing an electrical contact through the encapsulation. As with the embodiment depicted in FIGS. 3A-3E and FIGS. 4A-4E, the contact resistance through the encapsulation sublayer is reduced by forming a cavity or channel within the encapsulation sublayer (either prior to, during, or after curing of the encapsulation sublayer) and filling said cavity or channel with an electrical contact material such as an electroconductive paste. The electrical contact completes an electrical connection to the metal nanowire layer.

FIG. 5A depicts a representative partial cross-section a conductive structure, showing metal nanowires dispersed on a substrate. A profusion of metal nanowires 502 is dispersed on a surface of the substrate 500 in any suitable manner.

The encapsulation sublayer 504 is disposed above the metal nanowire layer, such as shown in FIG. 5B. A cure mold 506 is over the encapsulation sublayer 504, such as shown in FIG. 5C. The cure mold 506 includes one or more protrusions that extend either partially or entirely into the encapsulation sublayer 504 material. The protrusions displace a portion of the encapsulation sublayer 504. In some embodiments, the cure mold 506 can be coated or sprayed with a mold release agent prior to application to the encapsulation sublayer 504.

In one example, the cure mold 506 is formed from a flexible material such as a polymeric material. In another example, the cure mold 506 is formed from a rigid material such as metal.

The encapsulation material is cured and the cure mold 506 removed, such as shown in FIGS. 5D-5E, behind one or more cavities such as the cavity 508 within the cured encapsulation sublayer. An electrical contact 510 is disposed within the cavity 508 (or cavities) of the encapsulation sublayer 504, such as shown in FIG. 5F.

As with other embodiments depicted and described herein, an electrical circuit is formed through the encapsulation sublayer 504 by electrically coupling the electrical contact 510 directly to the metal nanowires 502 deposited on the substrate 500. Such a configuration exhibits lower electrical resistance than would be provided by an encapsulation sublayer 504 of equal thickness. In this manner, the metal nanowire layer is effectively encapsulated while retaining low sheet resistance.

In another related embodiment, and as described above with respect to FIGS. 4A-4E, the cavity 508 may not extend through the entire depth of the encapsulation sublayer 504. In another non-limiting phrasing, the cure mold 506 may extend only partly into the encapsulation sublayer 504. In this embodiment, the depth of the cavity can be selected based, at least in part, on the conductivity of the material selected for the encapsulation sublayer 504. For example, if the encapsulation sublayer 504 is formed from an electrically-conductive material with high conductivity, then the cavity may be shallower than if the encapsulation sublayer 504 is formed from an electrically-conductive material with low conductivity.

As with the depicted embodiment, the electrical contact 510 is disposed within the cavity 508 of the encapsulation sublayer 504. In this manner, an electrical circuit is formed through the thickness of the encapsulation sublayer 504 by electrically coupling the electrical contact 510 through a thin portion of the encapsulation sublayer 504, to the metal nanowires 502 deposited on the substrate 500. Such a configuration exhibits lower electrical resistance than would be provided by an encapsulation sublayer 504 of equal thickness. In this manner, the profusion of metal nanowires 502 is effectively encapsulated while retaining low sheet resistance.

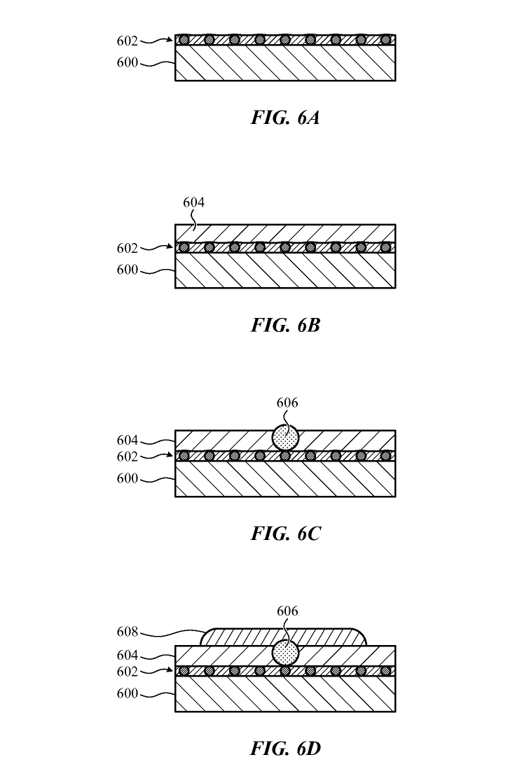

FIGS. 6A-6D depict intermediate operations of another method of forming a conductive structure that is substantially optically transparent on a substrate 600 by encapsulating a profusion of metal nanowires 602 and disposing an electrical contact 608 within the encapsulation sublayer 604. Here, the contact resistance through the encapsulation sublayer 604 is reduced by embedding a conductive insert 606 within the encapsulation sublayer (either prior to, during, or after curing of the encapsulation sublayer). An electrical contact 608 is disposed over the embedded insert.

As illustrated, the conductive insert 606 is spherical, although this is not required in all embodiments. In one example, the conductive insert 606 is a substantially spherical metal contact. In other examples, the conductive insert 606 takes the form of a rectangular shape, a square shape, a cylindrical shape, a polyhedral shape, an oblong shape, or can take any other suitable geometric shape. The exterior surface of the conductive insert 606 can be smooth, although this is not required; it may be instead jagged, faceted, irregular, and so on.

As with other embodiments depicted and described herein, an electrical circuit is formed through the encapsulation sublayer 604 by electrically coupling the electrical contact 608 directly to the metal nanowires 602 deposited on the substrate 600. Such a configuration exhibits lower electrical resistance than would be provided by an encapsulation sublayer 604 of equal thickness. In this manner, the metal nanowire layer is effectively encapsulated while retaining low sheet resistance.

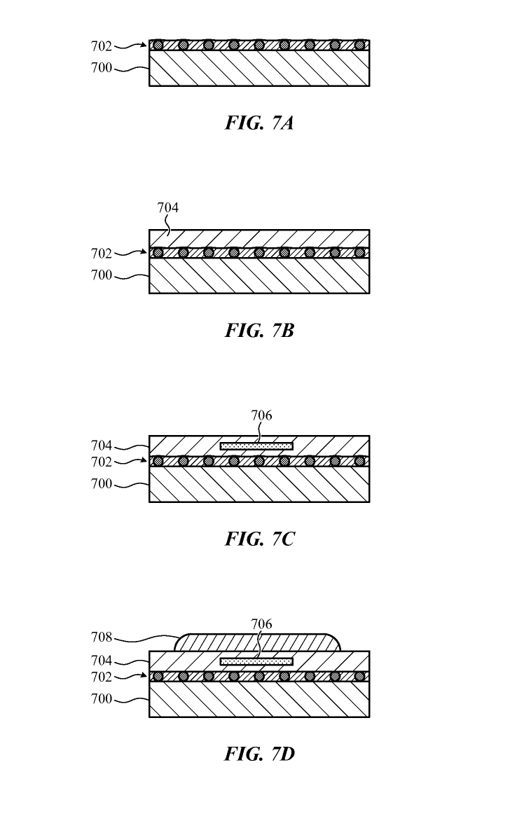

FIGS. 7A-7D depict intermediate operations of another method of forming a conductive structure that is substantially optically transparent on a substrate 700 by encapsulating a profusion of metal nanowires 702 and embedding an insert 706 within the encapsulation sublayer 704. Thereafter an electrical contact 708 can be disposed above the portion of the encapsulation sublayer 704 that is above the insert 706. As with the embodiment depicted in FIGS. 6A-6D, the contact resistance through the encapsulation sublayer 704 is reduced by embedding the insert within the encapsulation sublayer 704 (either prior to, during, or after curing of the encapsulation sublayer 704).

As with other embodiments depicted and described herein, an electrical circuit is formed through the electrical contact 708, through a thin portion of the encapsulation sublayer 704, through the insert 706, through a second thin portion of the encapsulation sublayer 704, to the metal nanowires 702. Such a configuration exhibits lower electrical resistance than would be provided by an encapsulation sublayer 704 of equal thickness. In this manner, the metal nanowire layer is effectively encapsulated while retaining low sheet resistance.

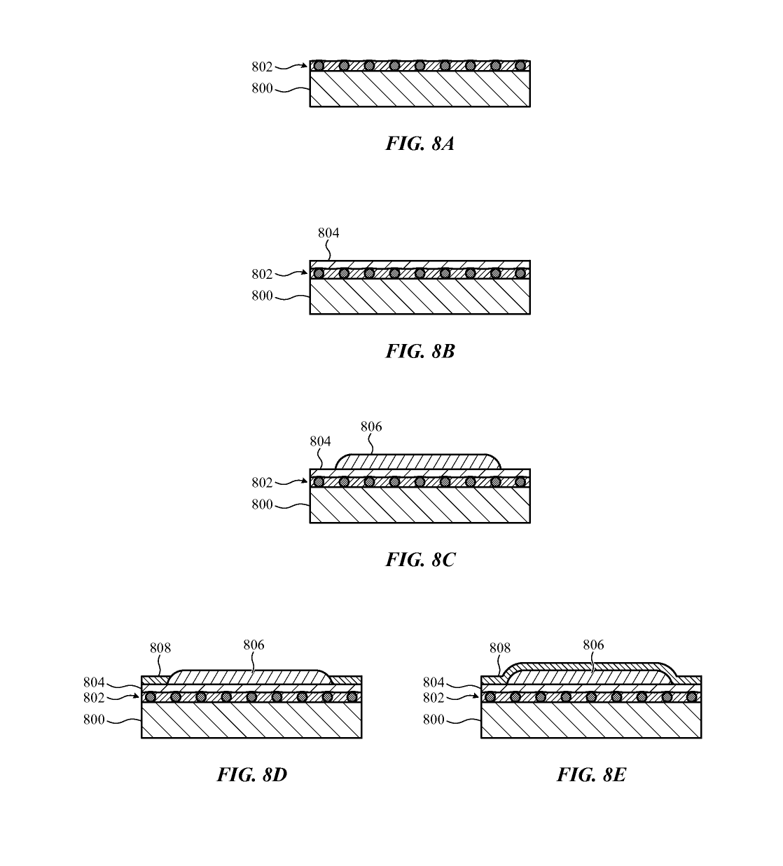

FIGS. 8A-8E depict intermediate operations of another method of forming a conductive structure that is substantially optically transparent on a substrate 800 by encapsulating a profusion of metal nanowires 802 with a first encapsulation sublayer 804. The thickness of the first encapsulation sublayer can be selected based, at least in part, on the conductivity of the material selected for the first encapsulation sublayer 804. For example, if the first encapsulation sublayer 804 is formed from an electrically-conductive material with high conductivity, then the first encapsulation sublayer 804 may be thinner than if the first encapsulation sublayer 804 is formed from an electrically-conductive material with low conductivity. An electrical contact 806 is disposed above the first encapsulation sublayer 804. A second encapsulation sublayer 808 is disposed over the electrical contact 806. The thickness of the second encapsulation sublayer 808 can be selected based, at least in part, on the electrical conductivity of the material selected for the second encapsulation sublayer 808. More specifically, the thickness of the second encapsulation sublayer 808 is selected based on the electrical resistance between the external surface of the second encapsulation sublayer 808 and an internal surface of the second encapsulation sublayer 808.

In one example, the second encapsulation sublayer 808 is disposed such that the electrical contact 806 stands proud of a top surface of the second encapsulation sublayer 808, such as depicted in FIG. 8D. The thickness of the second encapsulation sublayer 808 can be selected so that the second encapsulation sublayer 808 does not encapsulate the electrical contact 806.

In another example, the second encapsulation sublayer 808 is disposed over the electrical contact 806, such as depicted in FIG. 8E. Here, the thickness of the second encapsulation sublayer 808 disposed over the electrical contact 806 is selected based on the electrical resistance between the external surface of the second encapsulation sublayer 808 and the electrical contact 806.

In some embodiments, the first encapsulation sublayer 804 is formed from the same material as the second encapsulation sublayer 808. In other embodiments, the second encapsulation sublayer 808 is formed from a different material. For example, the second encapsulation sublayer 808 can be a protective film or an adhesive. In many cases, the second encapsulation sublayer 808 is electrically conductive, although this is not required of all embodiments.

For the embodiment depicted in FIG. 8D, an electrical circuit is formed through the electrical contact 806, through the first encapsulation sublayer 804, to the metal nanowires 802. Such a configuration exhibits lower electrical resistance than would be provided by an encapsulation sublayer of equal thickness. In this manner, the metal nanowire layer is effectively encapsulated while retaining low sheet resistance.

For the embodiment depicted in FIG. 8E, an electrical circuit is formed through the second encapsulation sublayer 808, through the electrical contact 806, through the first encapsulation sublayer 804, to the metal nanowires 802. Such a configuration exhibits lower electrical resistance than would be provided by an encapsulation sublayer of equal thickness. In this manner, the metal nanowire layer is effectively encapsulated while retaining low sheet resistance.

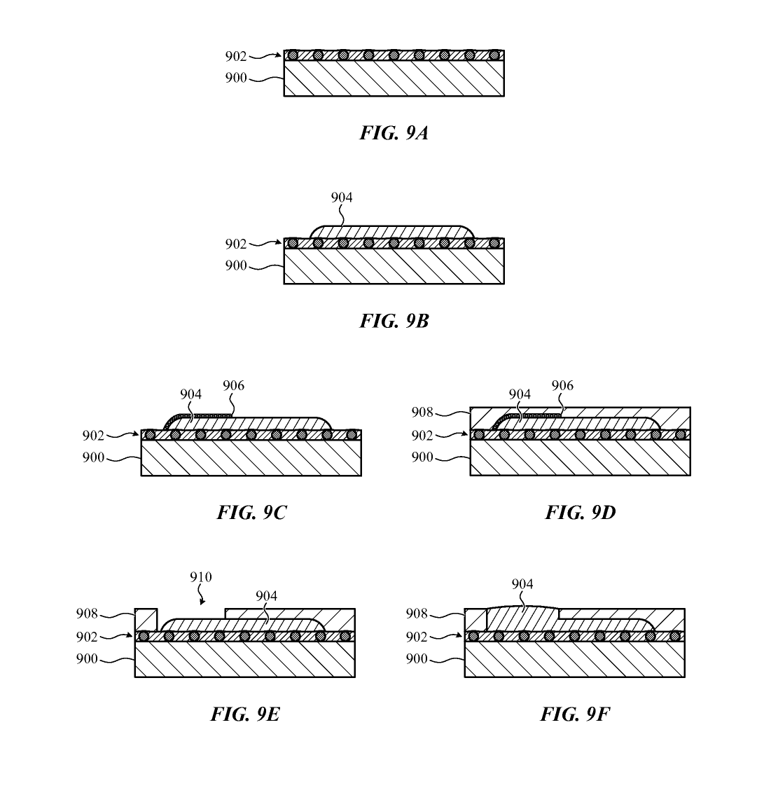

FIGS. 9A-9F depict intermediate operations of another method of forming a conductive structure that is substantially optically transparent on a substrate 900 by encapsulating a profusion of metal nanowires 902 and disposing an electrical contact 904 through the encapsulation sublayer 908. As with the embodiment depicted in FIGS. 3A-3E and FIGS. 4A-4E, the contact resistance through the encapsulation sublayer is reduced by forming a cavity 910 or channel within the encapsulation sublayer 908 by applying a masking agent 906 to the electrical contact 904 prior to curing of the encapsulation sublayer 908. After curing of the encapsulation sublayer 908, the cavity 910 can be exposed by removing the masking agent 906. Thereafter, the cavity 910 can be filled by an electrically-conductive material. In some cases, the electrically-conductive material is the same material as the electrical contact 904.

In this manner, an electrical circuit is formed through the encapsulation sublayer 908 by electrically coupling the electrical contact 904 directly to the metal nanowires deposited on the substrate 900. Such a configuration exhibits lower electrical resistance than would be provided by an encapsulation sublayer of equal thickness. In this manner, the profusion of metal nanowires 902 is effectively encapsulated while retaining low sheet resistance.

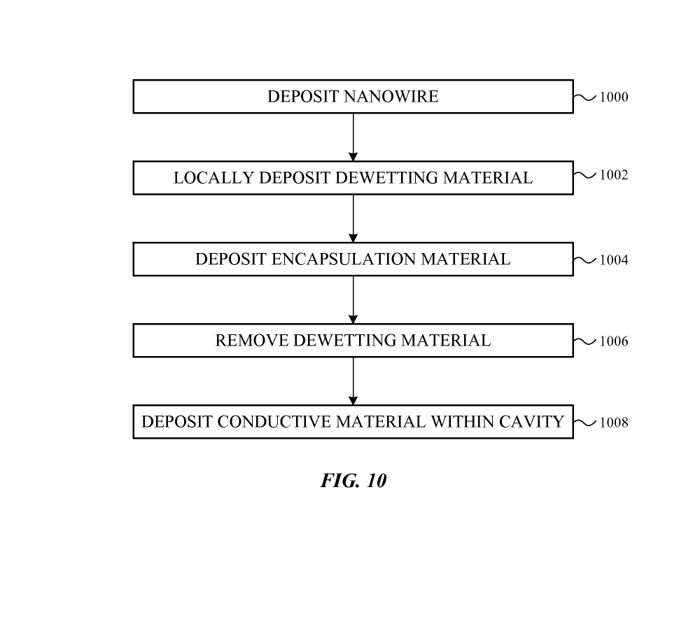

FIG. 10 is a simplified flow chart illustrating example operations of yet another method of forming a conductive structure that is optically transparent and exhibits reduced contact resistance. As with other embodiments described herein, the conductive structure is deposited on a substrate and includes a metal nanowire layer protected from corrosion by an encapsulation sublayer.

In these embodiments, the contact resistance through the encapsulation sublayer is reduced by forming the encapsulation sublayer with a cavity or channel and filling said cavity or channel with an electrical contact. The electrical contact completes an electrical connection to the metal nanowire layer. The thickness of the encapsulation sublayer is selected so as to provide encapsulation of the metal nanowire layer at least through the operational life of an electronic device incorporating the same. For example, the encapsulation may be thinner in a consumer electronic device than in an industrial electronic device.

As with the embodiment depicted in FIGS. 3A-3E, the method begins at operation 1000 in which the profusion of metal nanowires is dispersed on a substrate. The metal nanowires are suspended in a non-corrosive solvent. Typically, the substrate is a non-conductive (e.g., dielectric) substrate such as glass or polyethylene terephthalate. As noted above, in some embodiments, the substrate is a polarizer layer of a display stack.

The solvent is a volatile or semi-volatile liquid such as water, ketones such as acetone, alcohols, aromatics, or other hydrocarbon-based solvents.

The profusion of metal nanowires is suspended in the solvent. The profusion of metal nanowires is drawn across the surface of the substrate at operation 1000. Shear forces resulting from the drawing process encourage the metal nanowires of the profusion (or at least a plurality thereof) to align in a common direction.

In some embodiments, the solvent can include dopants, binders, or other additives that confer desirable properties to the solvent. In one example, an additive controls the viscosity of the profusion of metal nanowires.

The solvent (and/or additives) is thereafter evaporated, or otherwise removed, leaving a layer of substantially commonly-oriented metal nanowires on the substrate.

Next, at operation 1002, a dewetting material is locally deposited on the metal nanowire layer. The dewetting material encourages dewetting of the encapsulation sublayer. The dewetting material can be hydrophobic or oleophobic or another material that encourages dewetting of the material selected for the encapsulation sublayer.

Next, at operation 1004, the encapsulation sublayer is disposed above the metal nanowire layer and the dewetting material, such as shown in FIG. 3C. The thickness of the encapsulation sublayer can be uniform or non-uniform. For example, a perimeter portion of the encapsulation sublayer may be thinner than an interior portion of the encapsulation sublayer.

Next, at operation 1006, the dewetting material can be removed. In one example, the encapsulation sublayer is cured prior to removal of the dewetting material. Curing may occur by exposing the encapsulation sublayer to ultraviolet light, pressure, or heat. The dewetting material is removed by evaporation, extraction, dissolution, or another suitable method. In some cases, the dewetting material can be electrically conductive and may not necessarily be removed.

Lastly, at operation 1006, an electrical contact is disposed within the cavity of the encapsulation sublayer, such as shown in FIG. 3E. In one example, the electrical contact is flush with a top surface of the cured encapsulation sublayer. In another embodiment, the electrical contact extends proud of the top surface of the cured encapsulation sublayer. In this example, the electrical contact can be disposed to overflow from the cavity; a portion of the electrical contact can interface and/or be adhered or coupled to a top surface of the cured encapsulation sublayer (see, e.g., FIG. 3E).

In this manner, an electrical circuit is formed through the encapsulation sublayer by electrically coupling the electrical contact directly to the metal nanowires deposited on the substrate. Such a configuration exhibits lower electrical resistance than would be provided by an encapsulation sublayer of equal thickness. In this manner, the metal nanowire layer is effectively encapsulated while retaining low sheet resistance.

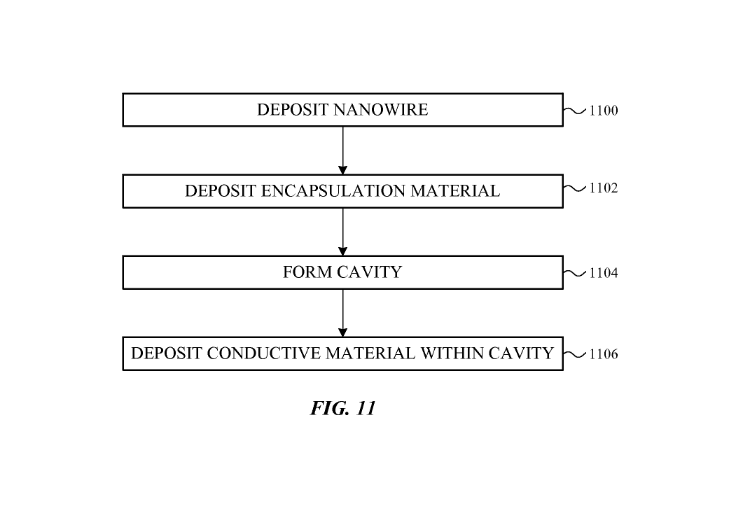

FIG. 11 is a simplified flow chart illustrating example operations of yet another method of forming a conductive structure that is optically transparent and exhibits reduced contact resistance. As with other embodiments described herein, the conductive structure is deposited on a substrate and includes a metal nanowire layer protected from corrosion by an encapsulation sublayer.

In these embodiments, the contact resistance through the encapsulation sublayer is reduced by forming a cavity or channel within the encapsulation sublayer (either prior to, during, or after curing of the encapsulation sublayer) and filling said cavity or channel with an electrical contact. The electrical contact completes an electrical connection to the metal nanowire layer.

The method begins at operation 1100 in which the profusion of metal nanowires is dispersed on a substrate. The metal nanowires are suspended in a non-corrosive solvent that is later evaporated, or otherwise removed.

Next, at operation 1102, the encapsulation sublayer is disposed above the metal nanowire layer. As with other embodiments described herein, the thickness of the encapsulation sublayer can be uniform or non-uniform.

Next, at operation 1104, a cavity is formed in the encapsulation sublayer. The cavity can extend entirely or partially through the depth of the encapsulation sublayer. In one example, the cavity is formed by etching (e.g., laser, chemical, particle blast, routing, photolithography, and so on). In some cases, a sacrificial material is deposited onto the nanowire layer prior to deposition of the encapsulation sublayer. A sacrificial material can be a laser light-absorbing material.

Lastly, at operation 1106, an electrical contact is disposed within the cavity (or cavities) of the encapsulation sublayer, such as shown in FIG. 4E. In one example, the electrical contact is flush with a top surface of the cured encapsulation sublayer. In another embodiment, the electrical contact extends proud of the top surface of the cured encapsulation sublayer. In this example, the electrical contact can be disposed to overflow from the cavity; a portion of the electrical contact can interface and/or be adhered or coupled to a top surface of the cured encapsulation sublayer (see, e.g., FIG. 4E).

In this manner, an electrical circuit is formed through the encapsulation sublayer by electrically coupling the electrical contact directly to the metal nanowires deposited on the substrate. Such a configuration exhibits lower electrical resistance than would be provided by an encapsulation sublayer of equal thickness. In this manner, the metal nanowire layer is effectively encapsulated while retaining low sheet resistance.

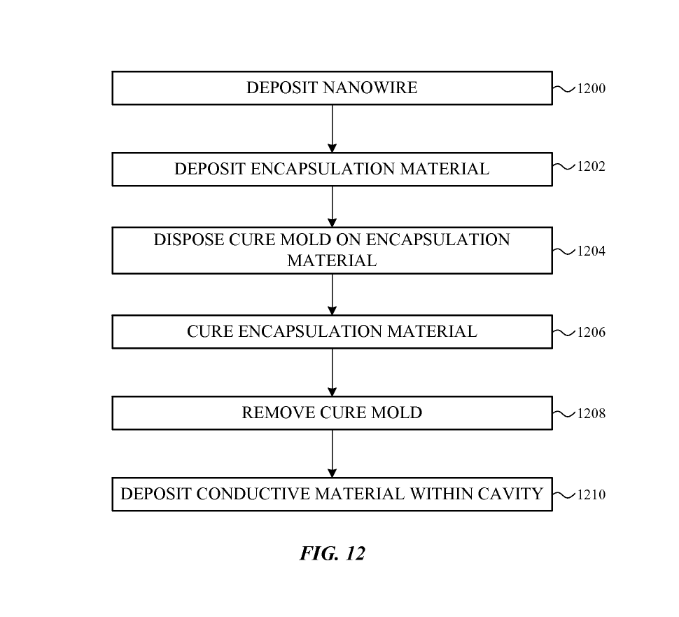

FIG. 12 is a simplified flow chart illustrating example operations of yet another method of forming a conductive structure that is optically transparent and exhibits reduced contact resistance. As with other embodiments described herein, the conductive structure is deposited on a substrate and includes a metal nanowire layer protected from corrosion by an encapsulation sublayer.

In these embodiments, the contact resistance through the encapsulation sublayer is reduced by molding a cavity or channel within the encapsulation sublayer and filling said cavity or channel with an electrical contact. The electrical contact completes an electrical connection to the metal nanowire layer.

The method begins at operation 1200 in which the profusion of metal nanowires (e.g., a profusion of metal nanowires in a solvent that is later dissolved) is dispersed on a substrate.

Next, at operation 1202, the encapsulation sublayer is disposed above the metal nanowire layer.

Next, at operation 1204 a cure mold is over the encapsulation sublayer. The cure mold includes one or more protrusions that extend either partially or entirely into the encapsulation sublayer material. The protrusions displace a portion of the encapsulation sublayer. In some embodiments, the cure mold can be coated or sprayed with a mold release agent prior to application to the encapsulation sublayer.

Next, at operation 1206, the encapsulation material is cured. In one example, curing may occur by exposing the encapsulation sublayer to ultraviolet light, pressure, or heat.

Next, at operation 1208, the cure mold is removed leaving behind one or more cavities within the cured encapsulation sublayer.

Lastly, at operation 1210, an electrical contact is disposed within the cavity (or cavities) of the encapsulation sublayer, such as shown in FIG. 5F. In one example, the electrical contact is flush with a top surface of the cured encapsulation sublayer. In another embodiment, the electrical contact extends proud of the top surface of the cured encapsulation sublayer. In this example, the electrical contact can be disposed to overflow from the cavity; a portion of the electrical contact can interface and/or be adhered or coupled to a top surface of the cured encapsulation sublayer (see, e.g., FIG. 5F).

In this manner, an electrical circuit is formed through the encapsulation sublayer by electrically coupling the electrical contact directly to the metal nanowires deposited on the substrate. Such a configuration exhibits lower electrical resistance than would be provided by an encapsulation sublayer of equal thickness. In this manner, the metal nanowire layer is effectively encapsulated while retaining low sheet resistance.

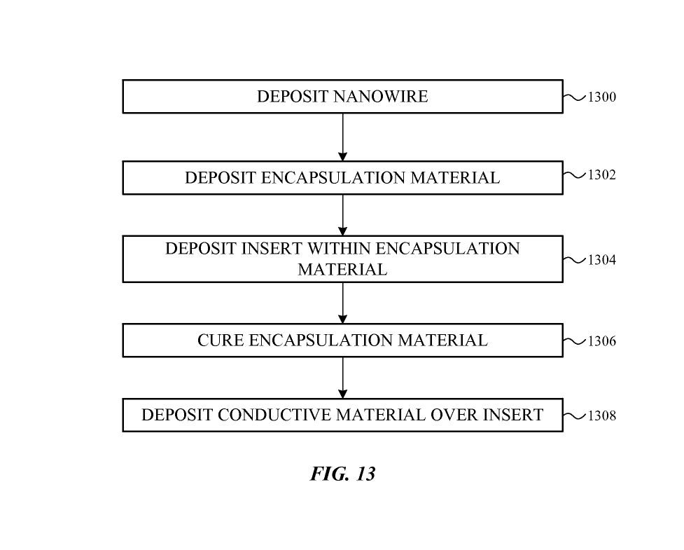

FIG. 13 is a simplified flow chart illustrating example operations of yet another method of forming a conductive structure that is optically transparent and exhibits reduced contact resistance. As with other embodiments described herein, the conductive structure is deposited on a substrate and includes a metal nanowire layer protected from corrosion by an encapsulation sublayer.

In these embodiments, the contact resistance through the encapsulation sublayer is reduced by including an electrically-conductive element within the encapsulation sublayer. The electrically-conductive element forms electrical path through the encapsulation sublayer.

The method begins at operation 1300 in which the profusion of metal nanowires (e.g., profusion of metal nanowires within a solvent) is deposited on a substrate. Next, at operation 1302, the encapsulation sublayer is disposed above the metal nanowire layer.

Next, at operation 1304 an electrically-conductive material is embedded within the encapsulation sublayer. The conductive material can be a metal plate, an electroconductive paste, or any other suitable electrically-conductive material. In one example, the electrically-conductive material has a thickness equal to that of the encapsulation sublayer; a top surface of the electrically-conductive material may be flush with a top surface of the encapsulation sublayer.

In another embodiment, the electrically-conductive material has a thickness greater than that of the encapsulation sublayer; the electrically-conductive material may protrude from a top surface of the encapsulation sublayer, such as depicted in FIGS. 6A-6C.

In another embodiment, the electrically-conductive material has a thickness that is less than that of the encapsulation sublayer; the electrically-conductive material is submerged entirely within the encapsulation sublayer, such as depicted in FIGS. 7A-7C. In such an embodiment, the encapsulation sublayer may be electrically conductive.

Next, at operation 1306, the encapsulation sublayer is cured. In one example, curing may occur by exposing the encapsulation sublayer to ultraviolet light, pressure, or heat.

Lastly, at operation 1308, an electrical contact is deposited on the top surface of the encapsulation sublayer, such as shown in FIG. 6D and/or FIG. 7D. The electrical contact is above and/or in contact with the conductive material disposed within the encapsulation sublayer. In one example, the electrical contact is adhered to the top surface of the electrical contact with an adhesive. The adhesive may be electrically conductive or electrically insulating. Typically, the electrical contact is an electroconductive paste.

In this manner, an electrical circuit is formed from the top surface of the electrical contact, through the electrically-conductive material (and potentially a thin portion of the encapsulation sublayer), to the metal nanowires deposited on the substrate. Such a configuration exhibits lower electrical resistance than would be provided by an encapsulation sublayer of equal thickness. In this manner, the metal nanowire layer is effectively encapsulated while retaining low sheet resistance.

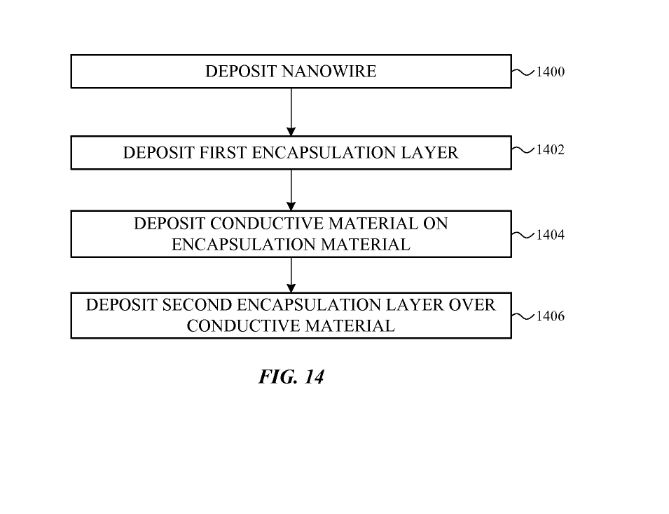

FIG. 14 is a simplified flow chart illustrating example operations of yet another method of forming a conductive structure that is optically transparent and exhibits reduced contact resistance. As with other embodiments described herein, the conductive structure is deposited on a substrate and includes a metal nanowire layer protected from corrosion by an encapsulation sublayer.

In these embodiments, the contact resistance through the encapsulation sublayer is reduced by dividing the encapsulation sublayer into multiple sub-layers and disposing an electrically-conductive element between said sublayers, such as depicted in FIGS. 8A-8E. The electrically-conductive element forms an electrical path through the encapsulation sublayer.

The method begins at operation 1400 in which a profusion of metal nanowires is dispersed on a substrate. As with other embodiments described herein, the metal nanowires are suspended in a solvent which is thereafter evaporated, or otherwise removed, leaving a layer of metal nanowires on the substrate.

Next, at operation 1402, a first encapsulation sublayer is disposed above the metal nanowire layer. The first encapsulation sublayer is formed from an electrically-conductive material has a thickness that provides a low electrical resistance between a top surface and a bottom surface thereof. In some embodiments, the first encapsulation sublayer can be partially or fully cured after and/or during operation 1402 is completed. In other embodiments, curing of the first encapsulation sublayer may not be required.

Next, at operation 1404 an electrically-conductive material is disposed above the first encapsulation sublayer. In other examples, the electrically-conductive material can be embedded partially or entirely within a cavity or channel defined within the first encapsulation sublayer. The electrically-conductive material can be a metal insert, an electroconductive paste, or any other suitable electrically-conductive material.

Next, at operation 1406, a second encapsulation sublayer is disposed over the first encapsulation sublayer. In some examples, the second encapsulation sublayer covers the electrically-conductive material deposited at operation 1404, such as depicted in FIG. 8E. In such an embodiment, the second encapsulation sublayer can also be formed from an electrically-conductive material and has a thickness that exhibits a low electrical resistance.

In this manner, an electrical circuit is formed from the top surface of the second encapsulation sublayer, through the second encapsulation sublayer, through the electrically-conductive material, through the first encapsulation sublayer, to the metal nanowires deposited on the substrate. Such a configuration exhibits lower electrical resistance than would be provided by an encapsulation sublayer of equal thickness.

In other embodiments, the second encapsulation sublayer does not cover the electrically-conductive material deposited at operation 1404, such as depicted in FIG. 8D. In such an embodiment, the second encapsulation sublayer can be formed of an electrically-conductive material or an electrically insulating material.

In this manner, an electrical circuit is formed from the top surface of the electrically-conductive material, through the first encapsulation sublayer, to the metal nanowires deposited on the substrate. As may be understood, such a configuration exhibits lower electrical resistance than would be provided by an encapsulation sublayer of equal thickness.

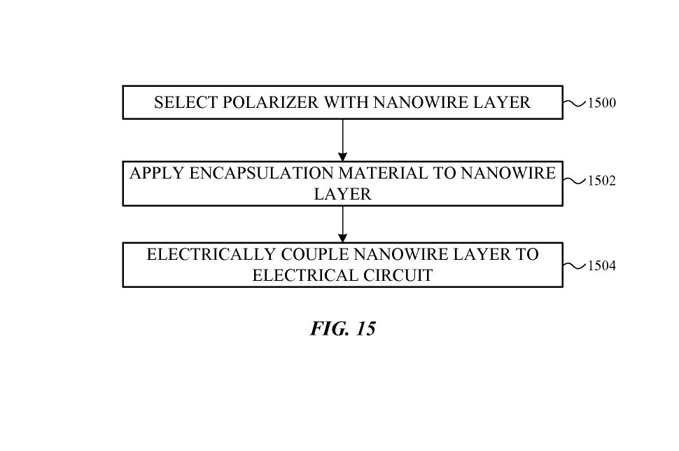

FIG. 15 is a simplified flow chart illustrating example operations of a method of coupling a conductive structure to an electrical circuit in a manner that reduces contact resistance therebetween. The method begins at operation 1500; a polarizer with a metal nanowire layer is selected.

In many embodiments, the metal nanowire layer is deposited (in a previous operation) on a bottom surface of the polarizer using a roll-to-roll process. The polarizer is typically made from an optically-transparent material that may be rigid or flexible. The polarizer may be made from an electrically-conductive or, more commonly, a dielectric material. The polarizer can be made from glass, sapphire, polycarbonates, acrylics, or any other suitable material.

The metal nanowire layer forms an interconnected conductive network of individual nanowires. The concentration of metal nanowires, among other factors, impacts the sheet resistance of the layer as well as the optical transparency thereof; the greater the concentration of metal nanowires, the lower the sheet resistance and optical transparency. Different embodiments dispose the metal nanowire layer in different concentrations. In some embodiments, the metal nanowire layer is deposited in a pattern, such as a grid.

The metal nanowire layer is encapsulated on the polarizer by an encapsulation sublayer at operation 1502. The encapsulation sublayer is formed from material that is optically transparent and may be either electrically conductive or insulating.

In some embodiments, the encapsulation sublayer is applied across the entire surface of the metal nanowire layer in a single operation. In other cases, the encapsulation sublayer is applied in multiple simultaneous and/or sequential operations by methods such as physical vapor deposition, sputtering, inkjet printing, rotogravure, offset printing, flexographic printing or another method.

In some embodiments, an electrical contact (e.g., metal paste, solder, a metal plate, and so on) is on a top surface of the encapsulation sublayer. At operation 1504, the electrical contact is coupled to an electrical circuit. The electrical contact cooperates with the encapsulation sublayer to form an electrical connection between the metal nanowire layer and an electrical circuit. In many embodiments, the thickness of the encapsulation sublayer is selected to reduce the contact resistance of said electrical connection. More particularly, the thicker the encapsulation sublayer, the greater the contact resistance. In many embodiments, the encapsulation sublayer is locally thinned (or removed) below the electrical contact.

In addition to and/or in place of local thinning, an electrically-conductive element can be disposed either partially or entirely within the encapsulation sublayer below the electrical contact. The electrically-conductive element serves to reduce the resistance between the electrical contact and the metal nanowire layer. The electrically-conductive element is a spherical metallic element in one embodiment, although other shapes may function in a similar manner. Such shapes include cylindrical inserts, cubic inserts, polyhedral inserts, irregularly-shaped inserts, oblong inserts, pointed inserts, triangular inserts, trapezoidal inserts, and so on. In another embodiment, the electrically-conductive element is a metal plate.

In many embodiments, an electrical contact is sized such that the insert is not visible to a user. In one non-limiting example, a dimension of the electrical contact is less than 10 micrometers. In other embodiments, a dimension of the electrical contact is less than 5 micrometers. In other embodiments, a dimension of the electrical contact is less than 2 micrometers

The electrical circuit can be any suitable electrical circuit. In one example, the electrical circuit is a sensor circuit such as a force sensor or a touch sensor. In another example, the electrical circuit is a communication circuit (either one-way or two-way).

In still another example, the electrical circuit is a switching circuit that is configured to selectively couple the optically-transparent electrically-conductive layer to more than one electrical circuit. For example, in a first mode, the optically-transparent electrically-conductive layer is coupled by the switching circuit to a sensor circuit. In a second mode, the optically-transparent electrically-conductive layer is coupled by the switching circuit to a communications circuit.

In many cases, the electrical contact is coupled to the electrical circuit by soldering. In other examples, the electrical contact is coupled to the electrical circuit via a flexible jumper circuit. In another example, the electrical contact is coupled to the electrical circuit via an electroconductive paste (e.g., silver paste, nickel paste, and so on). In further examples, the electrical contact may be omitted and the electrical circuit may couple directly to the top surface of the encapsulation sublayer.

Although many embodiments described and depicted herein reference input sensor systems for portable electronic device, it should be appreciated that other implementations can take other form-factors. Additionally, although many embodiments are described herein reference input sensor systems configured to sense force input, it should be appreciated that other input types can be used. Thus, the various embodiments described herein, as well as functionality, operation, components, and capabilities thereof may be combined with other elements as necessary, and so any physical, functional, or operational discussion of any element or feature is not intended to be limited solely to a particular embodiment to the exclusion of others.

For example, although the electronic device 100 is shown in FIG. 1 is a cellular telephone, it may be appreciated that other electronic devices are contemplated. For example, the electronic device 100 can be implemented as a peripheral input device, a desktop computing device, a handheld input device, a tablet computing device, a cellular phone, a wearable device, and so on.

Further, it may be appreciated that, for simplicity of illustration, the electronic device 100 can include one or more components that interface or interoperate, either directly or indirectly, with a conductive structure, are not depicted in FIG. 1. For example, the electronic device 100 may include a processor coupled to or in communication with a memory, a power supply, one or more sensors, one or more communication interfaces, and one or more input/output devices such as a display, a speaker, a rotary input device, a microphone, an on/off button, a mute button, a biometric sensor, a camera, a force and/or touch sensitive trackpad, and so on.

In some embodiments, the communication interfaces provide electronic communications between the electronic device 100 and an external communication network, device or platform. The communication interfaces can be implemented as wireless interfaces, Bluetooth interfaces, universal serial bus interfaces, Wi-Fi interfaces, TCP/IP interfaces, network communications interfaces, or any conventional communication interfaces. In one example, the communication interfaces are coupled to a conductive structure as described above.

The electronic device 100 may provide information related to externally connected or communicating devices and/or software executing on such devices, messages, video, operating commands, and so forth (and may receive any of the foregoing from an external device), in addition to communications. As noted above, for simplicity of illustration, the electronic device 100 is depicted in FIG. 1 without many of these elements, each of which may be included, partially, optionally, or entirely, within a housing.

In some embodiments, a housing of the electronic device 100 can form an outer surface or partial outer surface and protective case for the internal components of the electronic device 100. In the illustrated embodiment, the housing is formed in a substantially rectangular shape, although this configuration is not required. The housing can be formed of one or more components operably connected together, such as a front piece and a back piece or a top clamshell and a bottom clamshell. Alternatively, the housing can be formed of a single piece (e.g., uniform body or unibody).

In some embodiments, a processor within the electronic device 100 can perform, coordinate, or monitor one or more tasks associated with the operation of one or more input sensor systems incorporated therein.

Further, although many embodiments described herein reference a single conductive structure, it may be appreciated that in some embodiments more than one conductive structure can be deposited on the same substrate or within a different layer of the same display stack. Some conductive structures have different concentrations of metal nanowires than other conductive structures. Some conductive structures can overlap other conductive structures, but this is not required. Some conductive structure can be disposed in a pattern. For example, the electronic device of FIG. 1 can include an array of individual input transparent conductive areas, organized as an array. The individual transparent conductive areas can operate separately or cooperatively.

Although many embodiments discussed herein reference silver, other suitable metal or metallic nanowires or nanoparticles may be suitable for inclusion in certain further embodiments. For example, other metallic nanowires (e.g., nickel, gold, platinum) may be substituted for or mixed with silver nanowires to provide features, functions and characteristics desirable for certain configurations of particular embodiments. For example, platinum nanowires may be mixed with silver nanowires in select ratios in order to provide a particular conductance, shielding effect, or optical transparency profile.

One may appreciate that although many embodiments are disclosed above, that the operations and steps presented with respect to methods and techniques described herein are meant as exemplary and accordingly are not exhaustive. One may further appreciate that alternate step order or, fewer or additional steps may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A conductive structure positioned below a cover of a display of an electronic device, the conductive structure comprising:
a metal nanowire layer;
an encapsulation layer disposed over the metal nanowire layer; and
an electrical contact disposed adjacent the encapsulation layer that electrically couples the metal nanowire layer to an electrical circuit disposed within a housing of the electronic device; wherein
a combination of the metal nanowire layer and the encapsulation layer is substantially transparent.

2. The conductive structure of claim 1, wherein the conductive structure is disposed adjacent to a polarizer layer of the display.

3. The conductive structure of claim 1, wherein the metal nanowire layer is a profusion of metal nanowires generally oriented in a common direction.

4. The conductive structure of claim 1, wherein:
the encapsulation layer defines a cavity; and
the electrical contact comprises a deposit of conductive paste disposed within the cavity and contacting the metal nanowire layer.

5. The conductive structure of claim 1, wherein:
the encapsulation layer comprises a conductive insert contacting the metal nanowire layer; and
the electrical contact is disposed above the conductive insert.

6. The conductive structure of claim 5, wherein the conductive insert comprises a substantially spherical metal.

7. The conductive structure of claim 1, wherein:
the encapsulation layer comprises a conductive insert at least partially within the encapsulation layer and adjacent to the metal nanowire layer; and
an electrical resistance between the conductive insert and metal nanowire layer is less than the electrical resistance between a top surface of the encapsulation layer and the metal nanowire layer.

8. The conductive structure of claim 1, wherein the encapsulation layer is formed from an optically clear material.

9. The conductive structure of claim 1, wherein:
the encapsulation layer is a first encapsulation layer;
the conductive structure further comprises a second encapsulation layer disposed over the electrical contact; and
a thickness of the second encapsulation layer is selected based on an electrical resistance between an external surface of the second encapsulation layer and the electrical contact.

10. The conductive structure of claim 1, wherein the electrical circuit is a capacitive sensor circuit configured to measure a capacitance associated with the conductive structure.

11. The conductive structure of claim 1, wherein the capacitance measured by the capacitive sensor corresponds to a magnitude of force applied by a user to the cover.

12. The conductive structure of claim 1, wherein:
the electrical circuit is a communication circuit; and
the conductive structure is an antenna.

13. A method of forming a conductive structure, the method comprising:
depositing a profusion of metal nanowires on a surface of a substrate;
depositing an encapsulation layer over the metal nanowires;
defining a cavity within the encapsulation layer; and
depositing a conductor within the cavity such that an electrical resistance between the conductor and the profusion of metal nanowires is less than the electrical resistance between a top surface of the encapsulation layer and the profusion of metal nanowires.

14. The method of claim 13, wherein the cavity comprises a through-hole and the conductor contacts at least a portion of the profusion of metal nanowires.

15. The method of claim 13, wherein the cavity comprises a recess.

16. The method of claim 13, wherein defining a cavity within the encapsulation layer comprises:
curing the encapsulation layer; and
ablating the encapsulation layer with a laser.

17. The method of claim 13, wherein defining a cavity within the encapsulation layer comprises:
curing the encapsulation layer;
applying a mask to the encapsulation layer; and
etching the encapsulation layer with an etchant.

18. The method of claim 13, wherein defining a cavity within the encapsulation layer comprises:
disposing a cure mold over the encapsulation layer;
curing the encapsulation layer;
removing the cure mold from the encapsulation layer.

19. The method of claim 13, wherein defining a cavity within the encapsulation layer comprises:
prior to depositing an encapsulation layer, disposing a dewetting material over the metal nanowires;
depositing an encapsulation layer over the metal nanowires;
curing the encapsulation layer; and
removing dewetting material.

20. The method of claim 19, wherein the dewetting material comprises an oleophobic material.

21. The method of claim 19, wherein the dewetting material comprises a hydrophobic material.

22. The method of claim 13, wherein the encapsulation layer is a first encapsulation layer, the method further comprising depositing a second encapsulation layer over the conductor.

23. The method of claim 22, wherein the first encapsulation layer has a thickness greater than a thickness of the second encapsulation layer.

24. The method of claim 13, wherein the profusion of metal nanowires is deposited using a roll-to-roll process.

25. The method of claim 13, wherein the conductor comprises at least one of silver paste or nickel paste.

26. A method of forming a conductive structure, the method comprising:
depositing a profusion of metal nanowires on a surface of a substrate;
depositing an encapsulation layer over the metal nanowires;
depositing a conductive insert within the encapsulation layer;
curing the encapsulation layer; and
depositing an electrical contact over the conductive insert such that the electrical resistance between the electrical contact and the profusion of metal nanowires is less than the electrical resistance between a top surface of the encapsulation layer and the profusion of metal nanowires.

27. The method of claim 26, wherein the encapsulation layer is a first encapsulation layer, the method further comprising depositing a second encapsulation layer over the electrical contact.

28. The method of claim 26, wherein the profusion of metal nanowires is deposited using a roll-to-roll process.

29. The method of claim 26, wherein the electrical contact comprises at least one of silver paste or nickel paste.
